(19) United States
(12) Patent Application Publication
(10) Pub. No.: US 2026/0127009 A1
(43) Pub. Date: May 7, 2026

(54) METHOD FOR DATA PROCESSING, COMPUTER DEVICE, AND STORAGE MEDIUM

(71) Applicant: Douyin Vision Co., Ltd., Beijing (CN)

(72) Inventors: Linglong YU, Beijing (CN); Ziyan LIN, Beijing (CN); Ke YAN, Beijing (CN)

(21) Appl. No.: 19/118,750

(22) PCT Filed: Feb. 2, 2024
(86) PCT No.: PCT/CN2024/075493

§ 371 Date: Apr. 4, 2025

(30) Foreign Application Priority Data
Feb. 13, 2023 (CN) 202310151619.1

(51) Int. Cl. G06F 9/445; G06F 21/44

(52) U.S. Cl. CPC G06F 9/44505; G06F 21/44

(57) ABSTRACT

The present disclosure provides a method for data processing, a computer device and a storage medium. And the method includes: acquiring configuration change information of configuration information of a target service; parsing the configuration change information to obtain information to be verified of the configuration change information, where the information to be verified is determined based on a target configuration item in the configuration change information and/or service running data of the target service for the configuration change information; determining a verification rule matched with the information to be verified, and performing verification processing on the information to be verified according to the verification rule to obtain a verification result; and determining an information review result of the configuration change information based on the verification result.

The present application claims priority to Chinese Patent Application No. 202310151619.1, filed on Feb. 13, 2023, the disclosure of which is incorporated herein by reference in its entirety as part of the present application.

### TECHNICAL FIELD

Embodiments of the present disclosure relate to a method for data processing, an apparatus, a computer device, and a storage medium.

### BACKGROUND

At present, after configuration change information is published, the configuration change information that is published may be monitored, and an alarm is given in a timely manner when there is an abnormality in the configuration change information that is published, thereby ensuring the accuracy of the configuration change information that is published.

However, a monitoring mode of monitoring all service links of a service system where the configuration change information is located corresponds to a relatively large abnormality trigger threshold, so that it is impossible to give an alarm in a timely manner when there is an abnormality in the configuration change information that is published, thereby affecting the timeliness, effectiveness, and accuracy of monitoring the configuration change information that is published, and further affecting the quality of the configuration change information that is published.

### SUMMARY

Embodiments of the present disclosure provide at least a method for data processing, an apparatus, a computer device, and a storage medium.

In a first aspect, an embodiment of the present disclosure provides a method for data processing, including: acquiring configuration change information of configuration information of a target service; parsing the configuration change information to obtain information to be verified of the configuration change information, where the information to be verified is determined based on a target configuration item in the configuration change information and/or service running data of the target service for the configuration change information; determining a verification rule matched with the information to be verified, and performing verification processing on the information to be verified according to the verification rule to obtain a verification result; and determining an information review result of the configuration change information based on the verification result.

In an optional implementation, parsing the configuration change information to obtain the information to be verified of the configuration change information includes: determining a target verification indicator of each target configuration item in the configuration change information based on the service running data of the target service for the configuration change information; and determining the target verification indicator as the information to be verified.

In an optional implementation, performing verification processing on the information to be verified according to the verification rule to obtain the verification result includes: determining a preset verification template associated with the target verification indicator, where the preset verification template includes a verification rule of a verification indicator, and the verification indicator is a verification indicator of at least one configuration item; determining a target verification rule associated with the target verification indicator in the preset verification template; and performing verification processing on the target verification indicator according to the target verification rule to obtain the verification result.

In an optional implementation, performing verification processing on the target verification indicator according to the target verification rule to obtain the verification result includes: determining a verification threshold of the target verification indicator according to the target verification rule; and comparing the target verification indicator with the verification threshold, and determining the verification result according to a comparison result.

In an optional implementation, performing verification processing on the information to be verified according to the verification rule to obtain the verification result includes: determining at least one target table including each target configuration item in a plurality of tables of a database; detecting whether configuration information of a target configuration item in the at least one target table is the identical to configuration information of a target configuration item in the configuration change information; and obtaining a verification result indicating that the verification fails when they are detected to be different.

In an optional implementation, performing verification processing on the information to be verified according to the verification rule to obtain the verification result includes: determining a data determination mode of the service running data; obtaining standard running data of the target service for the configuration change information based on the configuration change information and the data determination mode; and comparing the standard running data with the service running data, and determining the verification result according to a comparison result.

In an optional implementation, the method further includes: when it is determined, based on the verification result, that there is abnormal information in the configuration change information, generating target alarm information; determining alarm accuracy information of the target alarm information based on historical alarm information; and when it is determined that the alarm accuracy information satisfies an alarm requirement, sending the target alarm information to an alarm verification party for verification processing.

In an optional implementation, the method further includes: determining a change state of the configuration change information; and when it is determined that the change state of the configuration change information is in a preset state, parsing the configuration change information to obtain the information to be verified of the configuration change information.

In a second aspect, an embodiment of the present disclosure further provides an apparatus for data processing, including: an acquisition module configured to acquire configuration change information of configuration information of a target service; a parsing module configured to parse the configuration change information to obtain information to be verified of the configuration change information, where the information to be verified is determined based on a target configuration item in the configuration change information and/or service running data of the target service for the configuration change information; a verification module configured to determine a verification rule matched with the information to be verified, and perform verification processing on the information to be verified according to the verification rule to obtain a verification result; and a determining module configured to determine an information review result of the configuration change information based on the verification result.

In a third aspect, an embodiment of the present disclosure further provides a computer device, including: a processor, a memory, and a bus, where the memory stores machine-readable instructions executable by the processor, the processor and the memory communicate through the bus when the computer device is running, and the machine-readable instructions, when executed by the processor, cause the processor to perform the steps in the first aspect or any one of the possible implementations of the first aspect.

In a fourth aspect, an embodiment of the present disclosure further provides a computer-readable storage medium, where the computer-readable storage medium has a computer program stored thereon, and the computer program, when run by a processor, causes the processor to perform the steps in the first aspect or any one of the possible implementations of the first aspect.

In order to make the above objects, features and advantages of the present disclosure more comprehensible, preferred embodiments are described in detail below with reference to the drawings.

### BRIEF DESCRIPTION OF DRAWINGS

In order to illustrate the technical solutions of the embodiments of the present disclosure more clearly, the drawings that need to be used in the embodiments will be briefly described below. The drawings are incorporated in and constitute a part of this specification, and the drawings illustrate embodiments consistent with the present disclosure and, together with the description, serve to explain the technical solutions of the present disclosure. It should be understood that the following drawings illustrate only some embodiments of the present disclosure, and therefore should not be considered as limiting the scope, and for those of ordinary skill in the art, other related drawings can be obtained from these drawings without creative effort.

FIG. 1 shows a flowchart of a method for data processing according to an embodiment of the present disclosure;

FIG. 2 shows a schematic flowchart of a process in which a method for data processing provided by an embodiment of the present disclosure is applied to a configuration backend;

FIG. 3 shows a schematic flowchart of a process of obtaining a verification result according to an embodiment of the present disclosure;

FIG. 4 shows a schematic diagram of an apparatus for data processing according to an embodiment of the present disclosure; and

FIG. 5 shows a schematic diagram of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and comprehensively below with reference to the drawings in the embodiments of the present disclosure. Obviously, the described embodiments are only a part of the embodiments of the present disclosure, but not all of them. The components of the embodiments of the present disclosure described and shown in the drawings herein may be arranged and designed in various different configurations. Therefore, the following detailed description of the embodiments of the present disclosure provided in the drawings is not intended to limit the scope of the claimed present disclosure, but merely represents selected embodiments of the present disclosure. Based on the embodiments of the present disclosure, all other embodiments obtained by those of ordinary skill in the art without creative effort shall fall within the protection scope of the present disclosure.

It should be noted that similar reference numerals and letters represent similar items in the following drawings, therefore, once an item is defined in one drawing, it does not need to be further defined and explained in subsequent drawings.

As used herein, the term “and/or” merely describes an association relationship and represents that there may be three relationships, for example, A and/or B may represent: three cases where A exists alone, both A and B exist, and B exists alone. In addition, the term “at least one” herein represents any one of a plurality of kinds or any combination of at least two of a plurality of kinds, for example, including at least one of A, B, and C may represent including any one or more elements selected from a set composed of A, B, and C.

It may be understood that before using the technical solutions disclosed in the embodiments of the present disclosure, users should be informed of the type, use range, use scenario, etc. of personal information involved in the present disclosure in an appropriate manner and authorization of the users should be obtained in accordance with relevant laws and regulations.

It is found through research that after the configuration change information is published, the configuration change information that is published may be monitored, and an alarm is given in a timely manner when there is an abnormality in the configuration change information that is published, thereby ensuring the accuracy of the configuration change information that is published.

However, for example, a monitoring mode of monitoring all service links of a service system where the configuration change information is located corresponds to a relatively large abnormality trigger threshold, so that it is impossible to give an alarm in a timely manner when there is an abnormality in the configuration change information that is published, thereby affecting the timeliness, effectiveness, and accuracy of monitoring the configuration change information that is published, and further affecting the quality of the configuration change information that is published.

Based on the above research, the present disclosure provides a method for data processing, an apparatus, a computer device, and a storage medium. In the embodiments of the present disclosure, after the configuration change information is acquired, the configuration change information may be parsed to obtain information to be verified of the configuration change information, where the information to be verified may be understood as configuration information in the configuration change information that needs to be verified. By means of parsing the configuration information in the configuration change information that needs to be verified, the information to be verified may be accurately extracted from the configuration change information, and redundant information that does not need to be verified may be filtered out from the configuration change information, thereby avoiding interference of the redundant information in the configuration change information with a verification process of the configuration change information and improving the verification efficiency of the configuration change information. Thereafter, a verification rule matched with the information to be verified may be determined, and verification processing is performed on the information to be verified according to the verification rule, so that accurate verification of the information to be verified can be achieved, thereby improving the accuracy of the information review result determined based on the verification result.

To facilitate understanding of this embodiment, a method for data processing disclosed in an embodiment of the present disclosure is first described in detail. An execution body of the method for data processing provided in the embodiment of the present disclosure is generally a computer device with a certain computing capability. In this case, a configuration backend may be configured in the computer device, and in this case, the method for data processing provided in the embodiment of the present disclosure may be applied to the configuration backend to process data in a service system.

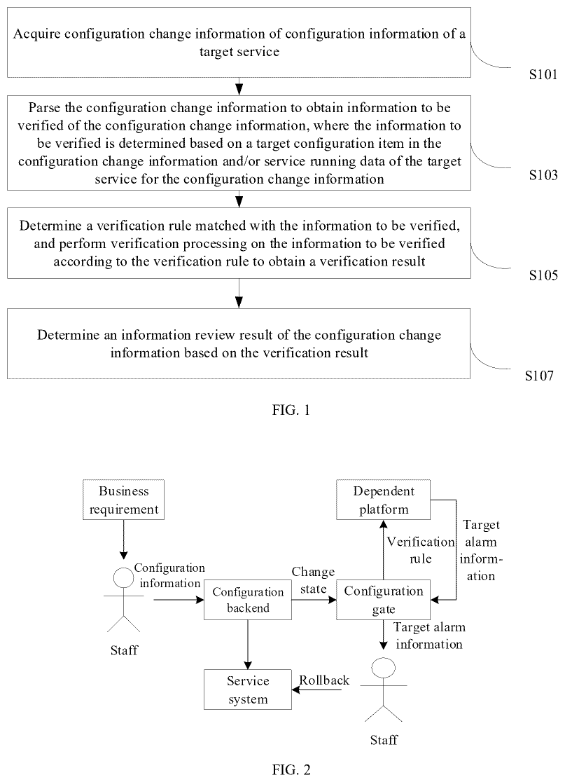

Referring to FIG. 1, it shows a flowchart of a method for data processing according to an embodiment of the present disclosure. The method for data processing includes steps S101 to S107, where:

S101: acquire configuration change information of configuration information of a target service.

In the embodiment of the present disclosure, the target service may indicate a specific service function in the service system, where the service system may be a payment system, a sales system, or the like. For example, when the service system is a payment system, the target service may be a payment service, a withdrawal service, a routing configuration service, or the like.

In the embodiment of the present disclosure, the configuration information of the target service may include at least the following information: information (e.g., a configuration item name, configuration item content, etc.) of each configuration item required when the target service is running in the service system, configuration time, configuration-related personnel, and the like.

In the embodiment of the present disclosure, when the target service needs to be updated, the target service may be updated based on configuration change information of configuration information corresponding to the target service. In this case, the configuration change information may include at least configuration item information that needs to be updated in the target service.

In the embodiment of the present disclosure, when it is detected that the target service is executed through the configuration change information, the configuration change information corresponding to the target service may be acquired, and then, the steps in S103 to S107 below may be executed.

S103: parse the configuration change information to obtain information to be verified of the configuration change information, where the information to be verified is determined based on a target configuration item in the configuration change information and/or service running data of the target service for the configuration change information.

In the embodiment of the present disclosure, the target configuration item in the configuration change information may be obtained by parsing the configuration change information; service running data when the target service is executed by the configuration change information may also be determined, so as to determine the information to be verified of the configuration change information based on the target configuration item and the service running data.

During specific implementation, a corresponding parsing type may be preset for the configuration change information, and a configuration item matching the parsing type is determined as the target configuration item in the configuration change information. Alternatively, an execution sequence of each configuration item in the configuration change information when the target service is executed may also be determined, and the target configuration item is determined from the configuration items based on the execution sequence.

Thereafter, the information to be verified of the configuration change information may be determined based on the target configuration item. For example, configuration content corresponding to the target configuration item may be determined as the information to be verified.

In another possible implementation, a database corresponding to the target service may be determined based on the configuration change information, and the service running data of the configuration change information when the target service is executed is determined in the database. In this case, the information to be verified of the configuration change information may be determined based on the service running data. The information to be verified may be the service running data, or a verification indicator of the configuration change information determined based on the service running data.

For example, the service running data may be flow data, and in this case, new data in the flow data may be determined as the information to be verified, or existing data in the flow data may be determined as the information to be verified, or the like.

For another example, the service running data may also be log data, and in this case, the information to be verified may be determined based on the log data. For example, error prompt information corresponding to the target configuration item in the log data may be determined as the data to be verified, or alarm information corresponding to the target configuration item in the log data may be determined as the information to be verified, or the like.

S105: determine a verification rule matched with the information to be verified, and perform verification processing on the information to be verified according to the verification rule to obtain a verification result.

In the embodiment of the present disclosure, a plurality of preset rules may be preset, and after the information to be verified is obtained, the verification rule matched with the information to be verified is determined based on the plurality of preset rules.

The verification rule may be used to indicate a method of verifying the information to be verified, for example, the information to be verified may be verified by means of threshold comparison. In this case, the verification rule may include a threshold for verifying the information to be verified. For another example, the information to be verified may be verified by means of data consistency comparison. In this case, the verification rule may include standard verification information of the information to be verified.

In the embodiment of the present disclosure, different verification rules may be set for different information to be verified. During specific implementation, an association relationship between each type of information and a verification rule may be preset, so as to determine a type matching the information to be verified based on the association relationship, and then, determine the verification rule of the information to be verified based on the matching type.

Each type of information may be associated with at least one verification rule, and verification rules associated with different types of information may be partially the same.

In the embodiment of the present disclosure, after the verification rule matched with the information to be verified is determined, verification processing may be performed on the information to be verified according to the verification rule to obtain the verification result. The verification result may include at least verification detail information and verification result prompt information.

The verification detail information is used to indicate a verification process of verifying the information to be verified, for example, various details such as the number of verification times and verification time of the information to be verified, and information whose verification fails in the information to be verified. The verification result prompt information is used to indicate whether the verification of the information to be verified is passed.

When the verification result prompt information indicates that the verification of the information to be verified fails, the verification result prompt information may include a reason for the verification failure, for example, the reason for the verification failure may be a data error, or excessive error prompt information, or the like.

S107: determine an information review result of the configuration change information based on the verification result.

In the embodiment of the present disclosure, when the verification result indicates that the verification is passed, it is determined that the information review result of the configuration change information is a review pass result; and when the verification result indicates that the verification fails, it is determined that the information review result of the configuration change information is a review failure result.

In another possible implementation, when the verification result indicates that the verification fails, the reliability of the verification result may also be determined based on the reason for the verification failure included in the verification result prompt information. When it is determined that the reliability of the verification result satisfies a requirement, it is determined that the information review result of the configuration change information is a review failure. When it is determined that the reliability of the verification result does not satisfy the requirement, it may be determined that the information review result of the configuration change information is a review pass.

In the embodiment of the present disclosure, after the configuration change information is acquired, the configuration change information may be parsed to obtain the information to be verified of the configuration change information, where the information to be verified may be understood as configuration information in the configuration change information that needs to be verified. By means of parsing the configuration information in the configuration change information that needs to be verified, the information to be verified may be accurately extracted from the configuration change information, and redundant information that does not need to be verified may be filtered out from the configuration change information, thereby avoiding interference of the redundant information in the configuration change information with a verification process of the configuration change information and improving the verification efficiency of the configuration change information. Thereafter, the verification rule matched with the information to be verified may be determined, and verification processing is performed on the information to be verified according to the verification rule, so that accurate verification of the information to be verified can be achieved, thereby improving the accuracy of the information review result determined based on the verification result.

In an optional implementation, after the configuration change information of the configuration information of the target service is acquired, a change state of the configuration change information may be determined, and when it is determined that the change state of the configuration change information is in a preset state, the configuration change information is parsed to obtain the information to be verified of the configuration change information.

In the embodiment of the present disclosure, the change state of the configuration change information may indicate a release state of the configuration change information, where the release state may indicate a state of whether the target service may be executed based on the configuration change information, for example, when the target service may be executed based on the configuration change information, it is determined that the configuration change information is in the released state; and when the target service cannot be executed based on the configuration change information, it is determined that the configuration change information is in the unreleased state.

In the embodiment of the present disclosure, the preset state may be understood as the released state, and in this case, when it is determined that the configuration change information is released, the configuration change information may be parsed to obtain the information to be verified of the configuration change information.

In the above implementation, after the configuration change information is acquired, the change state of the configuration change information may be determined, and when the change state is in the preset state, the configuration change information is parsed, so that invalid parsing of the configuration change information can be avoided, and the performance of data processing is improved.

In an optional implementation, after it is determined that the change state of the configuration change information is in the preset state, for S103: parsing the configuration change information to obtain the information to be verified of the configuration change information, the following steps are specifically included:
Step S21: determining a target verification indicator of each target configuration item in the configuration change information based on the service running data of the target service for the configuration change information; and
Step S22: determining the target verification indicator as the information to be verified.

The service running data may be understood as data generated by the configuration change information in a process of executing the target service, for example, the service running data may be log data, flow data, or the like.

In the embodiment of the present disclosure, a corresponding parsing type may be preset for the configuration change information, and a configuration item matching the parsing type is determined as the target configuration item in the configuration change information. Alternatively, an execution sequence of each configuration item in the configuration change information when the target service is executed may also be determined, and the target configuration item is determined from the configuration items based on the execution sequence.

In the embodiment of the present disclosure, after the target configuration item is determined, the service running data corresponding to each target configuration item may be determined, and the target verification indicator corresponding to each target configuration item is determined based on a data type included in the service running data corresponding to each target configuration item.

In the embodiment of the present disclosure, a plurality of verification indicators may be preset, and a verification indicator matching a data type included in the service running data corresponding to the target configuration item is determined as the target verification indicator. For example, the plurality of verification indicators may include: a response time indicator, a request failure times indicator, a memory overflow error, or the like. When it is determined that the service running data corresponding to the target configuration item includes a response time, a target verification indicator corresponding to the target configuration item may be set to: a response duration indicator of the target configuration item; when it is determined that the service running data corresponding to the target configuration item includes a response success traffic, a target verification indicator corresponding to the target configuration item may be set to: a response success times indicator of the target configuration item; and when it is determined that the service running data corresponding to the target configuration item includes a request failure traffic, a target verification indicator corresponding to the target configuration item may be set to: a request failure times indicator of the target configuration item.

In the embodiment of the present disclosure, the target verification indicator may be determined as the information to be verified. Thereafter, for S105: performing verification processing on the information to be verified according to the verification rule to obtain the verification result, the following steps are specifically included:
Step S31: determining a preset verification template associated with the target verification indicator, where the preset verification template includes a verification rule of a verification indicator, and the verification indicator is a verification indicator of at least one configuration item;
Step S32: determining a target verification rule associated with the target verification indicator in the preset verification template; and
Step S33: performing verification processing on the target verification indicator according to the target verification rule to obtain the verification result.

In the embodiment of the present disclosure, a plurality of preset verification templates may be set for a plurality of verification indicators of each configuration item in the configuration information of the target service, each preset verification template may include at least one verification rule, and each verification rule may be used to verify one verification indicator of each configuration item.

In the embodiment of the present disclosure, a mapping relationship between the configuration change information and the plurality of preset verification templates may be acquired, and the preset verification template associated with the target verification indicator is determined based on the mapping relationship and the target verification indicator. The mapping relationship between the configuration change information and the plurality of preset verification templates is determined based on a mapping relationship between the configuration information of the target service and the plurality of preset verification templates.

In the embodiment of the present disclosure, after the preset verification template associated with the target verification indicator is determined, the target verification rule associated with the target verification indicator in the preset verification template may be determined, and verification processing is performed on the target verification indicator of the target configuration item according to the target verification rule to obtain the verification result.

In the above implementation, by means of performing the verification processing on the target verification indicator according to the target verification rule, the configuration change information may be verified more accurately, so that problems existing in the configuration change information may be found in a timely and rapid manner, thereby improving the verification quality of the configuration change information.

In the embodiment of the present disclosure, there is at least one preset verification template associated with the target verification indicator. In this case, in a process of performing verification processing on the target verification indicator of the target configuration item according to the target verification rule, the verification processing may be performed on the target verification indicator according to the target verification rule associated with the target verification indicator in each of the preset verification templates, or the target verification rule associated with the target verification indicator in each of the preset verification templates may be copied and aggregated to obtain a new verification rule, and the verification processing is performed on the target verification indicator according to the new verification rule.

In the embodiment of the present disclosure, when the preset verification template associated with the target verification indicator includes a verification rule other than the target verification rule, a disable processing may be performed on the verification rule other than the target verification rule, and only normal operation of the target rule in the preset verification template is ensured, so that the verification progress of the target verification indicator may be accelerated, and the verification efficiency is improved.

In another possible implementation, a new verification rule may be determined based on the target verification rule associated with the target verification indicator in the preset verification template, and the new verification rule and the preset verification rule are enabled at the same time, and verification processing is performed on the service running data of the target service at the same time. In this case, not only the target verification information of each target configuration item in the configuration change information may be verified, but also the service running data of other configuration information in the target service may be verified, so that the impact of the configuration change information on the other configuration information in the target service may be determined based on the verification result, thereby avoiding the configuration change information from affecting the running state of the other configuration information in the target service, thereby improving the robustness and accuracy of the verification processing of the configuration change information.

In an optional implementation, for the above step S33: performing verification processing on the target verification indicator according to the target verification rule to obtain the verification result, the following steps are included:
Step S41: determining a verification threshold of the target verification indicator according to the target verification rule; and
Step S42: comparing the target verification indicator with the verification threshold, and determining the verification result according to a comparison result.

In the embodiment of the present disclosure, the target verification rule may include at least the following information: a preset verification threshold, a verification method, a verification result display form, a threshold update method, or the like.

In the embodiment of the present disclosure, after the target verification rule associated with the target verification indicator is determined in the preset verification template, the preset verification threshold in the target verification rule may be updated according to a threshold update method in the target verification rule, to obtain a verification threshold matching the target verification indicator of the target configuration item. In this case, the matching verification threshold is the verification threshold of the target verification indicator.

For example, the threshold update method may be: acquiring a historical verification record of the target verification rule, determining the number of verification times of each configuration item under a verification indicator corresponding to the target verification indicator based on verification data in the historical verification record, determining a threshold to be updated based on the number of verification times, and then updating the preset verification threshold in the target verification rule according to the threshold to be updated.

In the embodiment of the present disclosure, after the verification threshold of the target verification indicator is determined according to the target verification rule, the target verification indicator may be compared with the verification threshold, and when it is determined, according to the comparison result, that the target verification indicator is greater than or equal to the verification threshold, it may be determined that the verification result is that the verification fails; and when it is determined, according to the comparison result, that the target verification indicator is less than the verification threshold, it may be determined that the verification result is that the verification is passed.

In the above implementation, the verification threshold of the target indicator may be determined based on the target verification rule, and the verification result of the target verification indicator may be determined based on the verification threshold, so that separate verification of the target verification indicator may be achieved, thereby improving the verification precision and verification efficiency of the target configuration item.

In an optional implementation, for the above S105: performing verification processing on the information to be verified according to the verification rule to obtain the verification result, the following steps are specifically included:
Step S51: determining at least one target table including each target configuration item in a plurality of tables of a database;
Step S52: detecting whether configuration information of the target configuration items in the at least one target table is the identical to configuration information of the target configuration items in the configuration change information; and
Step S53: obtaining a verification result indicating that the verification fails when they are detected to be different.

In the embodiment of the present disclosure, the at least one target table including each target configuration item may be determined based on storage positions of each target configuration item in the configuration change information in the database. The configuration information of one target configuration item may be included in one target table, or the configuration information of a plurality of target configuration items may be included in one target table.

In a possible implementation, after the at least one target table including each target configuration item is determined, the configuration information of the target configuration items in the at least one target table may be scanned in full, and whether the configuration information of the target configuration items in the at least one target table is the identical to the configuration information of the target configuration items in the configuration change information is detected.

In another possible implementation, after the at least one target table including each target configuration item is determined, the configuration information of the target configuration items in the at least one target table may be scanned in real time, and whether the configuration information of the target configuration items in the at least one target table is the identical to the configuration information of the target configuration items in the configuration change information is detected.

In the embodiment of the present disclosure, the at least one target table may be associated through an association relationship between each target configuration item, for example, the target table 1 includes configuration information of a target configuration item 1, and the target table 2 includes configuration information of a target configuration item 2. When there is an association relationship A between the target configuration item 1 and the target configuration item 2, there is also the association relationship A between the target table 1 and the target table 2.

Based on this, after determining the at least one target table including each target configuration item, whether the configuration information of each target configuration item in the at least one target table is associated may be detected based on the association relationship between the respective target tables. For example, when there is a country-currency association relationship between the target configuration item 1 and the target configuration item 2, assuming that the configuration information of the target configuration item 1 included in the target table 1 is: country 1, and the configuration information of the target configuration item 2 included in the target table 2 is: currency 1, whether the configuration information in the target table 1: country 1 is associated with the configuration information in the target table 2: currency 1 may be detected.

In the embodiment of the present disclosure, when they are detected to be different (or not related), it is determined that the verification result is that the verification fails.

In the above implementation, the verification result may be determined by means of detecting the configuration information of the target configuration items stored in the at least one target table in the database and the configuration information of the target configuration items in the configuration change information, so that whether a storage error occurs in the configuration change information in a process of executing the target service may be detected, and the impact of the storage error on the running of the target service is avoided.

In an optional implementation, for the above S105: performing verification processing on the information to be verified according to the verification rule to obtain the verification result, the following steps are included:
Step S61: determining a data determination mode of the service running data;
Step S62: obtaining standard running data of the target service for the configuration change information based on the configuration change information and the data determination mode; and
Step S63: comparing the standard running data with the service running data, and determining the verification result according to a comparison result.

In the embodiment of the present disclosure, the data determination mode may indicate a calculation manner of calculating the configuration information of the target configuration item to obtain the service running data. For example, the data determination mode may be M+N, or M+N+P*Q, or the like.

In the embodiment of the present disclosure, the target configuration item corresponding to the service running data may be determined first, and then, the data determination mode of the service running data may be determined based on a service running mode of the target configuration item in the target service. For example, the target service is a withdrawal service, and when the target configuration item is a withdrawal account, the service running data corresponding to the withdrawal account may be an account balance and a withdrawal amount. In this case, the service running mode corresponding to the account balance of the service running data may be: account balance=account balance−withdrawal amount. In this case, the service running mode may be determined as the data determination mode.

In the embodiment of the present disclosure, after the data determination mode of the service running data is determined, the configuration information of the target configuration item corresponding to the service running data may be determined, and the configuration information is calculated according to the data determination mode of the service running data to obtain the standard running data of the target service for the configuration change information.

Thereafter, the standard running data may be compared with the service running data, and when it is determined that the standard running data is the identical to the service running data, it is determined that the verification result is that the verification is passed, and when it is determined that the standard running data is different from the service running data, it is determined that the verification result is that the verification fails.

In the above implementation, the service running data may be verified through the data determination mode of the service running data and the configuration change information, so that the accuracy of the service running data may be verified, to ensure the correctness of the flow data of the configuration change information in a process of executing the target service, so that the verification processing of the configuration change information may be more comprehensive, which makes up for the deficiency of only monitoring the verification indicator of the configuration item in the configuration change information, and improves the performance of the verification processing of the configuration change information.

In the embodiment of the present disclosure, when the verification result indicating that the verification is passed is determined based on any one of the above optional implementations, prompt information indicating that the verification is passed may be generated, and the prompt information indicating that the verification is passed is sent to a target object, where the target object may be at least one of: a person in charge corresponding to the configuration change information, a service party corresponding to the configuration change information, or the like. A sending mode corresponding to the prompt information indicating that the verification is passed may be sending a short message, sending an email, group notification, or the like.

In an optional implementation, when it is determined, based on the verification result, that there is abnormal information in the configuration change information, target alarm information is generated. Thereafter, alarm accuracy information of the target alarm information may be determined based on historical alarm information, and when it is determined that the alarm accuracy information satisfies an alarm requirement, the target alarm information is sent to an alarm verification party for verification processing.

In the embodiment of the present disclosure, when the verification result is that the verification fails, it is determined that there is abnormal information in the configuration change information. In this case, the target alarm information may be generated, where the target alarm information may include at least one of: verification detail information, the verification result, a reason for the verification failure, or the like.

In the embodiment of the present disclosure, the alarm accuracy information may indicate the accuracy of the target alarm information, for example, the alarm accuracy information may be 80% or 50% or the like.

In the embodiment of the present disclosure, the alarm accuracy information of the target alarm information may be determined based on the historical alarm information, for example, the identification model may be trained based on the historical alarm information to obtain a trained identification model, and thereafter, the generated target alarm information may be input into the trained identification model for identification processing to obtain the alarm accuracy information of the target alarm information.

The alarm requirement may be that the alarm accuracy information satisfies a preset accuracy threshold, for example, the alarm requirement may be: the alarm accuracy information is greater than or equal to 80%.

When it is determined that the alarm accuracy information satisfies the alarm requirement, the target alarm information may be sent to the alarm verification party for verification processing. The alarm verification party may be a person associated with the configuration change information, or may be a configuration backend where the configuration change information is located.

At this time, the alarm verification party may perform verification processing on the alarm accuracy information to obtain a verification processing result of the alarm accuracy information. The verification processing result may be that the verification is correct, or may be that the verification is wrong.

At this time, the alarm accuracy information and the verification processing result corresponding to the alarm accuracy information may be used as a training sample of the above identification model to train the identification model, so that the identification model may be further optimized, and the identification precision of the identification model is improved.

In the above implementation, when it is determined, based on the verification result, that there is abnormal information in the configuration change information, the target alarm information may be generated, and the alarm information accuracy information of the target alarm information is determined based on the historical alarm information, so that the verification processing of the target alarm information by the alarm verification party may be better assisted based on the historical alarm information, thereby improving the verification precision of the configuration change information.

In an optional implementation, as shown in FIG. 2, the method for data processing provided by the embodiment of the present disclosure may be applied to a configuration backend. In this case, after it is detected that the staff submits the configuration change information determined based on the configuration requirement to the configuration backend, the configuration change information (that is, the configuration change information of the configuration information of the target service) may be acquired. Thereafter, a configuration gate may be invoked to determine a change state of the configuration change information, and when it is determined that the change state of the configuration change information is in a preset state, the configuration change information is parsed to obtain the information to be verified of the configuration change information.

The configuration platform may be associated with a service system to which the target service belongs, and the target service is executed in the service system based on the configuration change information.

Thereafter, a dependent platform associated with the configuration gate may be invoked based on the verification rule matched with the information to be verified in the configuration gate, and the verification processing is performed on the information to be verified based on the dependent platform to obtain the verification result.

At this time, when it is determined, based on the verification result, that there is abnormal information in the configuration change information, the target alarm information is generated, and the configuration gate is invoked to determine the alarm accuracy information of the target alarm information. When it is determined that the alarm accuracy information satisfies the alarm requirement, the target alarm information is sent to an alarm verification party (for example, the staff as shown in FIG. 2) for verification processing.

At this time, when it is determined, based on the verification processing result, that the verification is correct, it is determined that there is abnormal information in the configuration change information. In this case, rollback prompt information may be generated, and a rollback operation is performed on the service system in response to a confirmation operation on the rollback prompt information.

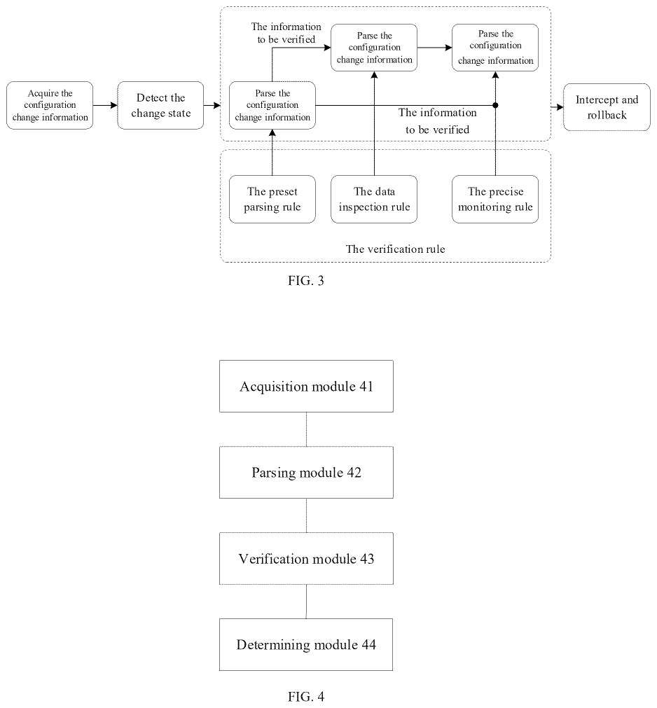

In the embodiment of the present disclosure, after the configuration change information is parsed to obtain the information to be verified, and the verification rule matched with the information to be verified is determined, a schematic flowchart of a process of performing verification processing on the information to be verified according to the verification rule to obtain the verification result may be shown in FIG. 3.

As can be seen from FIG. 3, when the configuration change information is acquired and it is detected that the change state of the configuration change information is the released state, the configuration change information may be parsed according to a preset parsing rule to obtain the information to be verified of the configuration change information.

Thereafter, the verification rule matched with the information to be verified may be determined, for example, when it is determined that the verification rule matched with the information to be verified is a data inspection rule, the verification processing may be performed on the information to be verified according to the steps described in the above steps S51 to S53 to obtain the verification result. Alternatively, when it is determined that the verification rule matched with the information to be verified is a precise monitoring rule, the verification processing may be performed on the information to be verified according to the steps described in the above steps S31 to S33 and/or the steps described in the above steps S41 to S42 to obtain the verification result.

Thereafter, when it is determined, based on the verification result, that there is abnormal information in the configuration change information, the configuration change information may be timely intercepted and the rollback operation is performed.

Those skilled in the art may understand that, in the above method in the specific implementations, the writing order of the steps does not imply a strict execution order and does not impose any limitation on the implementation process, and the specific execution order of the steps should be determined according to their functions and possible internal logic.

Based on the same inventive concept, the embodiments of the present disclosure further provide an apparatus for data processing corresponding to the method for data processing. Since the principle of solving the problem by the apparatus in the embodiments of the present disclosure is similar to the method for data processing in the embodiments of the present disclosure described above, the implementation of the apparatus may refer to the implementation of the method, and the repeated content will not be repeated.

Referring to FIG. 4, it shows a schematic diagram of an apparatus for data processing according to an embodiment of the present disclosure. The apparatus for data processing includes: an acquisition module 41, a parsing module 42, a verification module 43, and a determining module 44; where,
the acquisition module 41 is configured to acquire configuration change information of configuration information of a target service;
the parsing module 42 is configured to parse the configuration change information to obtain information to be verified of the configuration change information, where the information to be verified is determined based on a target configuration item in the configuration change information and/or service running data of the target service for the configuration change information;
the verification module 43 is configured to determine a verification rule matched with the information to be verified, and perform verification processing on the information to be verified according to the verification rule to obtain a verification result; and
the determining module 44 is configured to determine an information review result of the configuration change information based on the verification result.

In the embodiment of the present disclosure, after the configuration change information is acquired, the configuration change information may be parsed to obtain the information to be verified of the configuration change information, where the information to be verified may be understood as configuration information in the configuration change information that needs to be verified. By means of parsing the configuration information in the configuration change information that needs to be verified, the information to be verified may be accurately extracted from the configuration change information, and redundant information that does not need to be verified may be filtered out from the configuration change information, thereby avoiding interference of the redundant information in the configuration change information with a verification process of the configuration change information and improving the verification efficiency of the configuration change information. Thereafter, the verification rule matched with the information to be verified may be determined, and verification processing is performed on the information to be verified according to the verification rule, so that accurate verification of the information to be verified can be achieved, thereby improving the accuracy of the information review result determined based on the verification result.

In a possible implementation, the parsing module 42 is further configured to determine a target verification indicator of each target configuration item in the configuration change information based on the service running data of the target service for the configuration change information; and determine the target verification indicator as the information to be verified.

In a possible implementation, the verification module 43 is further configured to determine a preset verification template associated with the target verification indicator, where the preset verification template includes a verification rule of a verification indicator, and the verification indicator is a verification indicator of at least one configuration item; determine a target verification rule associated with the target verification indicator in the preset verification template; and perform verification processing on the target verification indicator according to the target verification rule to obtain the verification result.

In a possible implementation, the verification module 43 is further configured to determine a verification threshold of the target verification indicator according to the target verification rule; and compare the target verification indicator with the verification threshold, and determine the verification result according to a comparison result.

In a possible implementation, the verification module 43 is further configured to determine at least one target table including each target configuration item in a plurality of tables of a database; detect whether configuration information of the target configuration items in the at least one target table is the identical to configuration information of the target configuration items in the configuration change information; and obtain a verification result indicating that the verification fails when they are detected to be different.

In a possible implementation, the verification module 43 is further configured to determine a data determination mode of the service running data; obtain standard running data of the target service for the configuration change information based on the configuration change information and the data determination mode; and compare the standard running data with the service running data, and determine the verification result according to a comparison result.

In a possible implementation, the apparatus is further configured to, when it is determined, based on the verification result, that there is abnormal information in the configuration change information, generate target alarm information; determine alarm accuracy information of the target alarm information based on historical alarm information; and when it is determined that the alarm accuracy information satisfies an alarm requirement, send the target alarm information to an alarm verification party for verification processing.

In a possible implementation, the apparatus is further configured to determine the change state of the configuration change information; and when it is determined that the change state of the configuration change information is in the preset state, parse the configuration change information to obtain the information to be verified of the configuration change information.

For the description of the processing flow of each module in the apparatus and the interaction flow between the modules, reference may be made to the related description in the above method embodiments, which will not be repeated here.

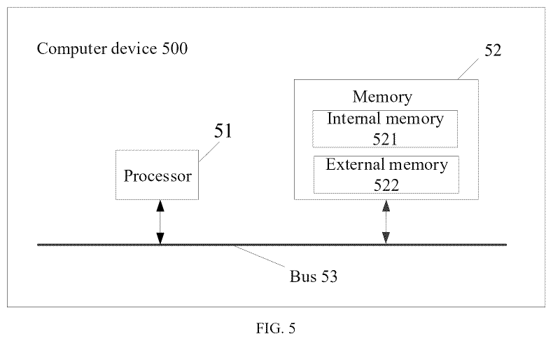

Corresponding to the method for data processing in FIG. 1, an embodiment of the present disclosure further provides a computer device 500. As shown in FIG. 5, it is a schematic structural diagram of the computer device 500 provided by an embodiment of the present disclosure, including:
a processor 51, a memory 52, and a bus 53; the memory 52 is used to store instructions for execution, including an internal memory 521 and an external memory 522; the internal memory 521 is also referred to as an internal memory, and is used to temporarily store operational data in the processor 51 and data exchanged with the external memory 522 such as a hard disk; the processor 51 exchanges data with the external memory 522 through the internal memory 521; and when the computer device 500 is running, the processor 51 communicates with the memory 52 through the bus 53, so that the processor 51 executes the following instructions:
acquiring the configuration change information of the configuration information of the target service;
parsing the configuration change information to obtain the information to be verified of the configuration change information, where the information to be verified is determined based on the target configuration item in the configuration change information and/or the service running data of the target service for the configuration change information;
determining the verification rule matched with the information to be verified, and performing verification processing on the information to be verified according to the verification rule to obtain the verification result; and
determining the information review result of the configuration change information based on the verification result.

An embodiment of the present disclosure further provides a computer-readable storage medium, where the computer-readable storage medium has a computer program stored thereon, and the computer program, when run by a processor, causes the processor to perform the steps of the method for data processing in the above method embodiments. The storage medium may be a volatile or non-volatile computer-readable storage medium.

Embodiments of the present disclosure further provide a computer program product, where the computer program product carries program codes, and instructions included in the program codes may be used to perform the steps of the method for data processing in the above method embodiments, which may specifically refer to the above method embodiments and will not be repeated here.

The above computer program product may be implemented in hardware, software, or a combination thereof. In an optional embodiment, the computer program product is embodied as a computer storage medium, and in another optional embodiment, the computer program product is embodied as a software product, such as a software development kit (Software Development Kit, SDK), and the like.

Those skilled in the art may clearly understand that, for the convenience and conciseness of description, the specific working process of the above-described system and apparatus may refer to the corresponding process in the foregoing method embodiments, which will not be repeated here. In the several embodiments provided by the present disclosure, it should be understood that the disclosed system, apparatus, and method may be implemented in other manners. The apparatus embodiments described above are merely illustrative, for example, the division of the modules is only a logical function division, and there may be other division manners in actual implementation. For another example, a plurality of modules or components may be combined or integrated into another system, or some features may be ignored or not implemented. In addition, the mutual coupling or direct coupling or communication connection shown or discussed may be through some communication interfaces, and the indirect coupling or communication connection of the apparatus or module may be electrical, mechanical, or other forms.

The modules described as separate parts may or may not be physically separate, and parts displayed as modules may or may not be physical modules, that is, they may be located at one place, or may be distributed on a plurality of network modules. Some or all of the modules may be selected according to actual needs to achieve the objectives of the solutions of the embodiments.

In addition, the functional modules in the embodiments of the present disclosure may be integrated into one processing module, or each of the modules may exist alone physically, or two or more modules may be integrated into one module.

The functions, if implemented in the form of software functional modules and sold or used as independent products, may be stored in a non-volatile computer readable storage medium executable by a processor. Based on such understanding, the technical solutions of the present disclosure essentially or the parts contributing to the prior art or the parts of the technical solutions may be embodied in the form of a software product, and the computer software product is stored in a storage medium and includes a plurality of instructions for causing a computer device (which may be a personal computer, a server, or a network device, etc.) to perform all or part of the steps of the methods described in the embodiments of the present disclosure. The above-mentioned storage medium includes various media that can store program codes, such as a USB flash drive, a mobile hard disk, a read-only memory (Read-Only Memory, ROM), a random access memory (Random Access Memory, RAM), a magnetic disk, or an optical disc.

Finally, it should be noted that the above-mentioned embodiments are only specific implementations of the present disclosure, and are used to illustrate the technical solutions of the present disclosure, but not to limit them. The protection scope of the present disclosure is not limited to this. Although the present disclosure has been described in detail with reference to the foregoing embodiments, those of ordinary skill in the art should understand that any technician familiar with the technical field can still modify or easily think of changes to the technical solutions described in the foregoing embodiments or make equivalent replacements to some of the technical features within the technical scope disclosed by the present disclosure; and these modifications, changes or replacements do not make the essence of the corresponding technical solutions deviate from the spirit and scope of the technical solutions of the embodiments of the present disclosure, and should be covered by the protection scope of the present disclosure. Therefore, the protection scope of the present disclosure should be subject to the protection scope of the claims.

1. A method for data processing, comprising:
acquiring configuration change information of configuration information of a target service;
parsing the configuration change information to obtain information to be verified of the configuration change information, wherein the information to be verified is determined based on a target configuration item in the configuration change information and/or service running data of the target service for the configuration change information;
determining a verification rule matched with the information to be verified, and performing verification processing on the information to be verified according to the verification rule matched with the information to be verified to obtain a verification result; and
determining an information review result of the configuration change information based on the verification result.

2. The method according to claim 1, wherein the parsing the configuration change information to obtain information to be verified of the configuration change information comprises:
determining a target verification indicator of each target configuration item in the configuration change information based on the service running data of the target service for the configuration change information; and
determining the target verification indicator as the information to be verified.

3. The method according to claim 2, wherein the performing verification processing on the information to be verified according to the verification rule matched with the information to be verified to obtain a verification result comprises:
determining a preset verification template associated with the target verification indicator, wherein the preset verification template comprises a verification rule of a verification indicator, and the verification indicator is a verification indicator of at least one configuration item;
determining a target verification rule associated with the target verification indicator in the preset verification template; and
performing verification processing on the target verification indicator according to the target verification rule to obtain the verification result.

4. The method according to claim 3, wherein the performing verification processing on the target verification indicator according to the target verification rule to obtain the verification result comprises:
determining a verification threshold of the target verification indicator according to the target verification rule; and
comparing the target verification indicator with the verification threshold, and determining the verification result according to a comparison result.

5. The method according to claim 1, wherein the performing verification processing on the information to be verified according to the verification rule matched with the information to be verified to obtain a verification result comprises:
determining at least one target table comprising each target configuration item in a plurality of tables of a database;
detecting whether configuration information of the target configuration item in the at least one target table is identical to configuration information of the target configuration item in the configuration change information; and
obtaining a verification result indicating that the verification fails when the configuration information of the target configuration item in the at least one target table and the configuration information of the target configuration item in the configuration change information are detected to be different.

6. The method according to claim 1, wherein the performing verification processing on the information to be verified according to the verification rule matched with the information to be verified to obtain a verification result comprises:
determining a data determination mode of the service running data;
obtaining standard running data of the target service for the configuration change information based on the configuration change information and the data determination mode; and
comparing the standard running data with the service running data, and determining the verification result according to a comparison result.

7. The method according to claim 1, further comprising:
when it is determined, based on the verification result, that there is abnormal information in the configuration change information, generating target alarm information;
determining alarm accuracy information of the target alarm information based on historical alarm information; and
when it is determined that the alarm accuracy information satisfies an alarm requirement, sending the target alarm information to an alarm verification party for verification processing.

8. The method according to claim 1, further comprising:
determining a change state of the configuration change information; and
when it is determined that the change state of the configuration change information is in a preset state, parsing the configuration change information to obtain the information to be verified of the configuration change information.

9. (canceled)

10. A computer device, comprising: a processor, a memory, and a bus, wherein the memory stores machine-readable instructions executable by the processor, the processor and the memory communicate through the bus when the computer device is running, and the machine-readable instructions, when executed by the processor, cause the processor to perform a method for data processing, wherein the method comprises:
acquiring configuration change information of configuration information of a target service;
parsing the configuration change information to obtain information to be verified of the configuration change information, wherein the information to be verified is determined based on a target configuration item in the configuration change information and/or service running data of the target service for the configuration change information;
determining a verification rule matched with the information to be verified, and performing verification processing on the information to be verified according to the verification rule matched with the information to be verified to obtain a verification result; and
determining an information review result of the configuration change information based on the verification result.

11. A non-transitory computer-readable storage medium, wherein the computer-readable storage medium has a computer program stored thereon, and the computer program, when run by a processor, causes the processor to perform a method for data processing, wherein the method comprises:
acquiring configuration change information of configuration information of a target service;
parsing the configuration change information to obtain information to be verified of the configuration change information, wherein the information to be verified is determined based on a target configuration item in the configuration change information and/or service running data of the target service for the configuration change information;
determining a verification rule matched with the information to be verified, and performing verification processing on the information to be verified according to the verification rule matched with the information to be verified to obtain a verification result; and
determining an information review result of the configuration change information based on the verification result.

12. The computer device according to claim 10, wherein the parsing the configuration change information to obtain information to be verified of the configuration change information comprises:
determining a target verification indicator of each target configuration item in the configuration change information based on the service running data of the target service for the configuration change information; and
determining the target verification indicator as the information to be verified.

13. The computer device according to claim 12, wherein the performing verification processing on the information to be verified according to the verification rule matched with the information to be verified to obtain a verification result comprises:
determining a preset verification template associated with the target verification indicator, wherein the preset verification template comprises a verification rule of a verification indicator, and the verification indicator is a verification indicator of at least one configuration item;
determining a target verification rule associated with the target verification indicator in the preset verification template; and
performing verification processing on the target verification indicator according to the target verification rule to obtain the verification result.

14. The computer device according to claim 13, wherein the performing verification processing on the target verification indicator according to the target verification rule to obtain the verification result comprises:
determining a verification threshold of the target verification indicator according to the target verification rule; and
comparing the target verification indicator with the verification threshold, and determining the verification result according to a comparison result.

15. The computer device according to claim 10, wherein the performing verification processing on the information to be verified according to the verification rule matched with the information to be verified to obtain a verification result comprises:
determining at least one target table comprising each target configuration item in a plurality of tables of a database;
detecting whether configuration information of the target configuration item in the at least one target table is identical to configuration information of the target configuration item in the configuration change information; and
obtaining a verification result indicating that the verification fails when the configuration information of the target configuration item in the at least one target table and the configuration information of the target configuration item in the configuration change information are detected to be different.

16. The computer device according to claim 10, wherein the performing verification processing on the information to be verified according to the verification rule matched with the information to be verified to obtain a verification result comprises:
determining a data determination mode of the service running data;
obtaining standard running data of the target service for the configuration change information based on the configuration change information and the data determination mode; and
comparing the standard running data with the service running data, and determining the verification result according to a comparison result.

17. The computer device according to claim 10, wherein the method further comprises:
when it is determined, based on the verification result, that there is abnormal information in the configuration change information, generating target alarm information;
determining alarm accuracy information of the target alarm information based on historical alarm information; and
when it is determined that the alarm accuracy information satisfies an alarm requirement, sending the target alarm information to an alarm verification party for verification processing.

18. The computer device according to claim 10, wherein the method further comprises:
determining a change state of the configuration change information; and
when it is determined that the change state of the configuration change information is in a preset state, parsing the configuration change information to obtain the information to be verified of the configuration change information.

19. The non-transitory computer-readable storage medium according to claim 11 wherein the parsing the configuration change information to obtain information to be verified of the configuration change information comprises:
determining a target verification indicator of each target configuration item in the configuration change information based on the service running data of the target service for the configuration change information; and
determining the target verification indicator as the information to be verified.

20. The non-transitory computer-readable storage medium according to claim 19, wherein the performing verification processing on the information to be verified according to the verification rule matched with the information to be verified to obtain a verification result comprises:
determining a preset verification template associated with the target verification indicator, wherein the preset verification template comprises a verification rule of a verification indicator, and the verification indicator is a verification indicator of at least one configuration item;
determining a target verification rule associated with the target verification indicator in the preset verification template; and
performing verification processing on the target verification indicator according to the target verification rule to obtain the verification result.

21. The non-transitory computer-readable storage medium according to claim 20, wherein the performing verification processing on the target verification indicator according to the target verification rule to obtain the verification result comprises:
determining a verification threshold of the target verification indicator according to the target verification rule; and
comparing the target verification indicator with the verification threshold, and determining the verification result according to a comparison result.
